(19) United States
(12) Patent Application Publication
(10) Pub. No.: US 2012/0208153 A1
(43) Pub. Date: Aug. 16, 2012

(54) Systems and Methods Providing Distributed Training Simulations

(75) Inventors: Veera Paparao Bolla, Hyderabad (IN); Clayton Synard, Greenville, SC (US); Chetan Udupa, Hyderabad (IN)

(73) Assignee: GENERAL ELECTRIC COMPANY, Schenectady, NY (US)

(21) Appl. No.: 13/028,707

(22) Filed: Feb. 16, 2011

(51) Int. Cl. G09B 19/00

(52) U.S. Cl. 434/219

(57) ABSTRACT

Systems and methods providing distributed training simulations are provided. A system may include a trainer station computer in operable communication with multiple trainee workstation computers. The trainer station computer can be operable to: facilitate simulation of plant operations on at least one of the trainee workstation computers; and monitor operations performed by at least one of the trainee workstation computers. The trainee workstation computers can be operable to: display the simulation of plant operations to a user; receive control instructions input to cause a change in the simulation of plant operations; and transmit to the trainer station computer information associated with at least one of: (a) the control instructions input; or (b) the change in the simulation of plant operations.

### TECHNICAL FIELD

The invention relates generally to training systems, and more particularly relates to systems and methods providing distributed training simulations.

### BACKGROUND OF THE INVENTION

System operations and control training is often performed using simulations of plant operations rather than using live control systems in production. Simulations allow software modeled plant operations to be executed and altered, providing widely configurable training environments. Thus, plant conditions and training scenarios can be provided to trainees at ease and without causing any impact on live plant operations. As simulation modeling continues to increase in sophistication, trainee experiences begin to closely approximate live plant operations conditions, while still having the flexibility of creating or forcing conditions and varied training scenarios.

However, conventional training systems are limited in their flexibility and adaptability to train and respond to multiple trainee systems.

Accordingly, there exists a need for systems and methods providing distributed training simulations.

### BRIEF DESCRIPTION OF THE INVENTION

Embodiments of the invention can address some or all of the needs described above. According to one embodiment, a system for simulating plant operations is provided. The system may include a trainer station computer in operable communication with multiple trainee workstation computers. The trainer station computer can be operable to: facilitate simulation of plant operations on at least one of the trainee workstation computers; and monitor operations performed by at least one of the trainee workstation computers. The trainee workstation computers can be operable to: display the simulation of plant operations to a user; receive control instructions to cause a change in the simulation of plant operations; and transmit to the trainer station computer information associated with at least one of: (a) the control instructions input; or (b) the change in the simulation of plant operations.

According to another embodiment, a method for simulating plant operations is provided. The method may include: providing a trainer station computer; providing multiple trainee workstation computers in operable communication with the trainer station computer; simulating plant operations on at least one of the trainee workstation computers; monitoring operations performed by at least one of the trainee workstation computers; and transmitting from at least one of the trainee workstation computers to the trainer station computer information associated with at least one of: (a) control instructions input at least one of the trainee workstation computers; or (b) a change in the simulation of plant operations resulting from the control instructions.

According to yet another embodiment, a system for simulating plant operations is provided. The system may include a trainer station computer in operable communication with multiple trainee workstation computers. The trainer station computer can be operable to: facilitate simulation of plant operations on multiple trainee workstation computers representing at least two different simulation conditions or at least two different plant components on at least two different trainee workstation computers; and monitor operations performed by at least one of the trainee workstation computers.

Other embodiments and aspects of the invention will become apparent from the following description taken in conjunction with the following drawings.

### BRIEF DESCRIPTION OF THE DRAWINGS

FIG. 1 is a block diagram representation of an example distributed training simulation system, according to one embodiment.

FIG. 2 is a flowchart illustrating an example method for providing distributed training simulations, according to one embodiment.

FIG. 3 is a block diagram illustrating an example computer system, according to one embodiment.

### DETAILED DESCRIPTION OF THE INVENTION

Example embodiments of the invention now will be described more fully hereinafter with reference to the accompanying drawings, in which some, but not all embodiments are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

According to various example embodiments of the invention, systems and methods can provide a distributed training system, such as is operable for simulating plant operations to provide operator training and/or to diagnose or test plant operations. A distributed training system can include a trainer station computer, which is operable to facilitate the computerized simulation of plant operations using any of numerous available plant simulation techniques. The trainer station computer is further operable to provide simulated training operations and scenarios to multiple trainee workstation computers and to monitor responses, control instructions, and operations performed at the trainee workstation computers in response to the simulated training operations. Moreover, the distributed training system embodiments described herein advantageously allow customized and unique interactions between the trainer station computer and each of the different trainee workstation computers, such that different trainees may undergo different training scenarios at the same time, all of which are at least partially controlled and monitored by the trainer at the trainer station computer.

As one example, at least one trainer can simulate plant operations using the trainer station computer and its corresponding simulation modules to represent a first training simulation for a first trainee and a second training simulation for a second trainee (or the same simulations for both trainee, in other examples). The trainer may then cause a different malfunction or other operation scenario for each of the trainee workstation computers, which the trainer station computer can monitor the trainee responses and control instructions to the changing scenarios. Trainee responses and control instructions entered to the trainee workstation computers can be stored and accessible by the trainer station computer. Moreover, the trainer station computer may be operative to allow monitoring, in real-time or near real-time, trainee reactions, control instructions, and operations, as well as playing back the trainee responses at a subsequent time for review. Furthermore, according to some embodiments, electronic (or “online”) chat sessions can be conducted between the trainer station computer and each of the trainee workstation computers, providing a discrete, efficient, and effective means for providing feedback and/or requesting assistance. Thus, a trainer utilizing a trainer station computer can interact with each trainee student differently, providing personalized training and guidance for each trainee during simultaneous training sessions performed in parallel by the trainer station computer and led by the trainer.

Accordingly, by allowing multiple parallel training sessions to be led for multiple different trainees by a single trainer, more effective training can be provided according to the embodiments described herein, while also improving efficiencies and reducing costs.

According to some embodiments of the invention, the distributed training simulation system may be operable for use in simulating plant operations and providing associated training therefor, such as, but not limited to, simulating control systems for use in steam turbine plants, gas turbine plants, combined-cycle plants, wind generators, solar power generation systems, and the like. It is appreciated, however, that other plant types and plant operations beyond those described by example herein may be simulated and the distributed training simulation system applied thereto. It is further appreciated that, in some embodiments, the distributed simulation system can be used for simulation and training for any system environment utilizing a computerized control system, any of which may generally be referred to herein as a “plant.” Accordingly, the embodiments described herein are provided as illustrative and are not limiting. Distributed training simulation systems have wide applicability to numerous system environments for which operations can be simulated.

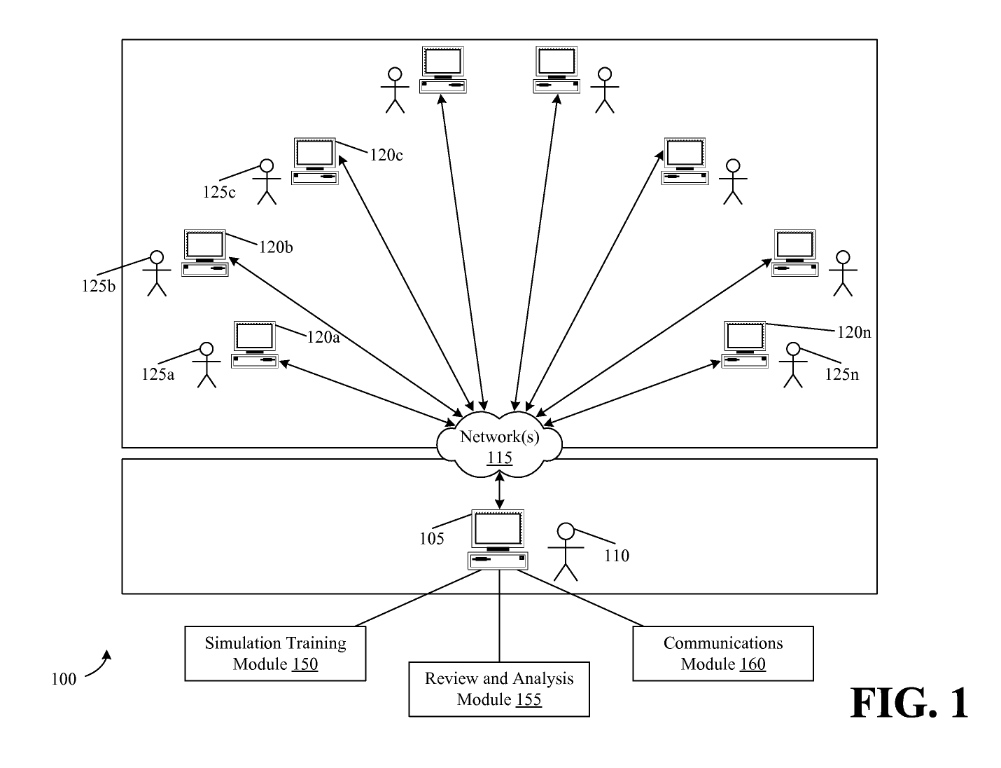

Example embodiments are now described with reference to FIGS. 1-3.

Referring to the drawings, FIG. 1 is a block diagram representation of a distributed training simulation system, according to one example embodiment. According to this embodiment, the training simulation system 100 includes at least one trainer station computer 105 and multiple trainee workstation computers 120a-120n, which are in communication over one or more networks 115. A trainer 110 may operate the trainer station computer 105 to lead distributed training simulations for each of multiple trainees 125a-125n using respective trainee workstation computers 120a-120n. Each of the aforementioned systems or system components is configured for accessing and reading associated computer-readable media having data stored thereon and/or computer-executable instructions for implementing the various methods described herein. By executing computer-executable instructions, each of these computer systems may form a special purpose computer or a particular machine. As used herein, the term “computer-readable medium” may describe any form of computer memory or memory device.

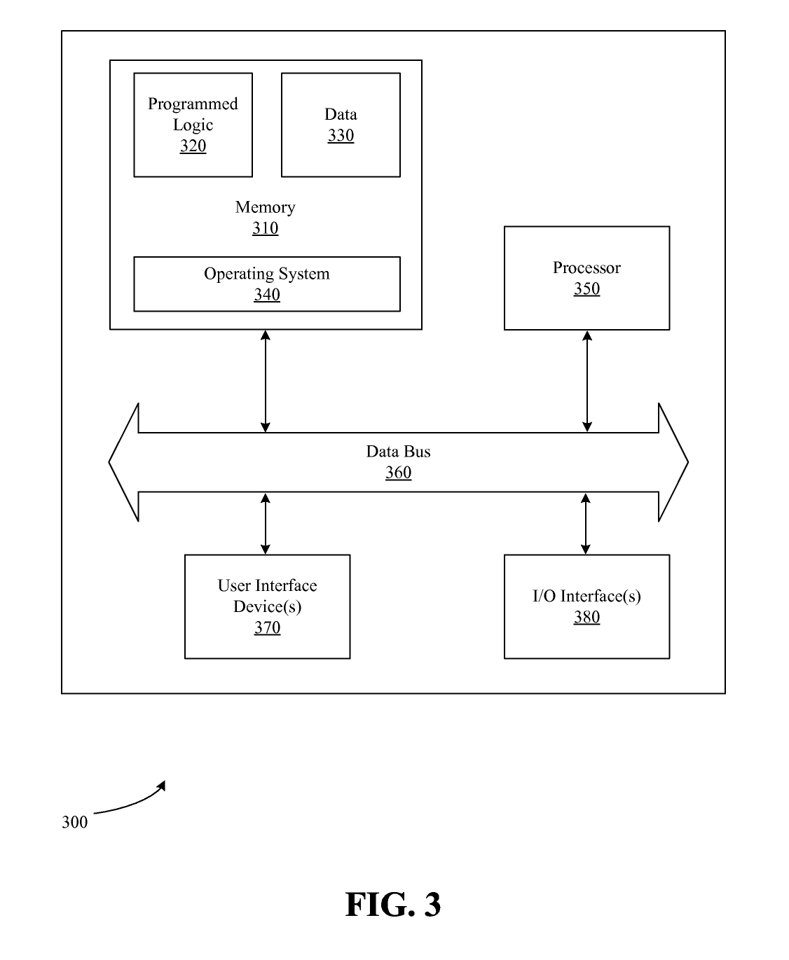

The trainer station computer 105 illustrated in FIG. 1 represents any system or systems comprising one or more computers or other processor-based devices for implementing various functions provided during distributed training simulations. A trainer station computer 105 may include, but is not limited to, a server computer, a personal computer, an Internet station, a mobile computing device, and the like. Additional detail of an example computer system and associated components is provided herein with reference to FIG. 3. The trainer station computer 105 may further include one or more modules including application programming operable to facilitate various aspects of the distributed training simulations. According to one embodiment, at least a simulation training module 150, a review and analysis module 155, and a communications module 160 are provided. The simulation training module 150, review and analysis module 155, and communications module 160 are represented in FIG. 1 as separate modules or components; however, it is appreciated that these components may represent logical functions implemented by a single physical device or may be provided, at least in part, by one or more separate physical devices.

A simulation training module 150 may include programming instructions operable to: configure and execute one or more plant simulations; configure and execute one or more training scenarios and altered plant operations; adjust simulations on a real-time or near real-time basis; schedule adjusted simulations; introduce complex plant malfunctions; force plant operation signals (e.g., measurements, sensed signals, etc.) to different values; store simulations and training scenarios in memory (e.g., in one or more databases or other local or remote data storage devices, etc.); generate simulated human machine interfaces (“HMIs”) for operable use at the one or more trainee workstation computers 120a-120n; recall or restore plant simulation to a previously-stored condition; communicate the aforementioned example operations over the network 115 for delivery and presentation to one or more of the trainee workstation computers 120a-120n; receive trainee responses and control instructions, and corresponding simulated operations, from one or more of the trainee workstation computers 120a-120n over the network 115; and the like.

A review and analysis module 155 may include programming instructions operable to: receive trainee responses and control instructions, and corresponding simulated operations, from one or more of the trainee workstation computers 120a-120n over the network 115; store received trainee responses and control instructions, and corresponding simulated operations, in memory (e.g., in one or more databases or other local or remote data storage devices, etc.); allow recalling received trainee responses and control instructions, and corresponding simulated operations, from memory for playing, pausing, stopping, and replaying trainee performance; generate trainee performance measurements (e.g., statistical, raw, etc.); display simulated system performance measurements (e.g., simulated plant performance resulting from trainee responses to simulated scenarios, etc.); generating reports based at least in part on simulations and trainee responses; and the like.

A communications module 160 may include programming instructions operable to: initiate text-based chat sessions with one or more trainee workstation computers 120a-120n over the network 115; initiate voice-based chat sessions with one or more trainee workstation computers 120a-120n over the network 115; receive communications (e.g., text-based or voice-based chat sessions, email, private messages, etc.) from one or more trainee workstation computers 120a-120n over the network 115; facilitate delivery of chat sessions between two or more trainee workstation computers 120a-120n; store chat session data in memory for subsequent retrieval, review, and analysis.

Each of the multiple trainee workstation computers 120a-120n illustrated in FIG. 1 represents any system or systems comprising one or more computers or other processor-based devices for implementing various functions provided during distributed training simulations and for use by one or more of the multiple trainees 125a-125n. Trainee workstation computers 120a-120n may include, but are not limited to, a personal computer, an Internet station, a server computer, a mobile computing device, and the like. For example, according to one embodiment, each of the trainee workstation computers 120a-120n may be personal communications in communication with the network 115 and, thus, operable to receive and transmit electronic communications with the trainee station computer 105. As mentioned, additional detail of an example computer system and associated components is provided herein with reference to FIG. 3. In one embodiment, each trainee workstation computer 120a-120n may include application programming generally operable to: display training plant simulations and training operations and scenarios; provide a user interface (e.g., HMI, etc.) for displaying simulation data and for receiving trainee input and control instructions; display simulated plant performance measurements; display trainee performance measurements; replay trainee responses and control commands to training simulations and scenarios; receive voice-based chat sessions from the trainer station computer 105 over the network 115; initiate communications (e.g., text-based or voice-based chat sessions, facetime or real-time video interaction, email, private messages, etc.) to the trainer station computer 105 over the network 115; receive and/or initiate chat or real-time communication sessions between other trainee workstation computers 120a-120n; and the like. In one embodiment, one or more of the trainee workstation computers 120a-120n are located at a location remote from the trainer station computer 105, such as in another room (e.g., in a class room distanced from the trainer), in another building, or even in another geographical region entirely. In one embodiment, the distributed training simulation system 100 may be provided as a web-based application, in which each of the trainee workstation computers 120a-120n is operable to interface with an HMI or other training environment hosted over a network (e.g., over the Internet at or by a web or other application server, etc.). In one example, the trainer station computer 105 may also be operable to interface with the training environment hosted over a network, such as to control the training simulation and/or to review and analyze trainee response data over the network. These distributed communication models between the trainer station computer 105 and the trainee workstation computers 120a-120n allow for more convenient and cost-effective training, while the operations performed by the communications module 160 still allow for personalized training, even for trainers located remote from trainees.

The network 115 may include any number of telecommunication and/or data networks, whether public, private, or a combination thereof, such as, but not limited to, the Internet, a local area network, a wide area network, an intranet, intermediate handheld data transfer devices, public switched telephone networks, and/or any combination thereof, which may be wired and/or wireless. Due to network connectivity, various methodologies described herein may be practiced in the context of distributed computing environments. Although the system 100 is shown for simplicity as including one network 115, it is to be understood that any other network configuration is possible, which may optionally include a plurality of networks, each with devices such as gateways and routers, for providing connectivity between or among networks.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the invention should not be construed as being limited to any particular operating environment, system architecture, or device configuration.

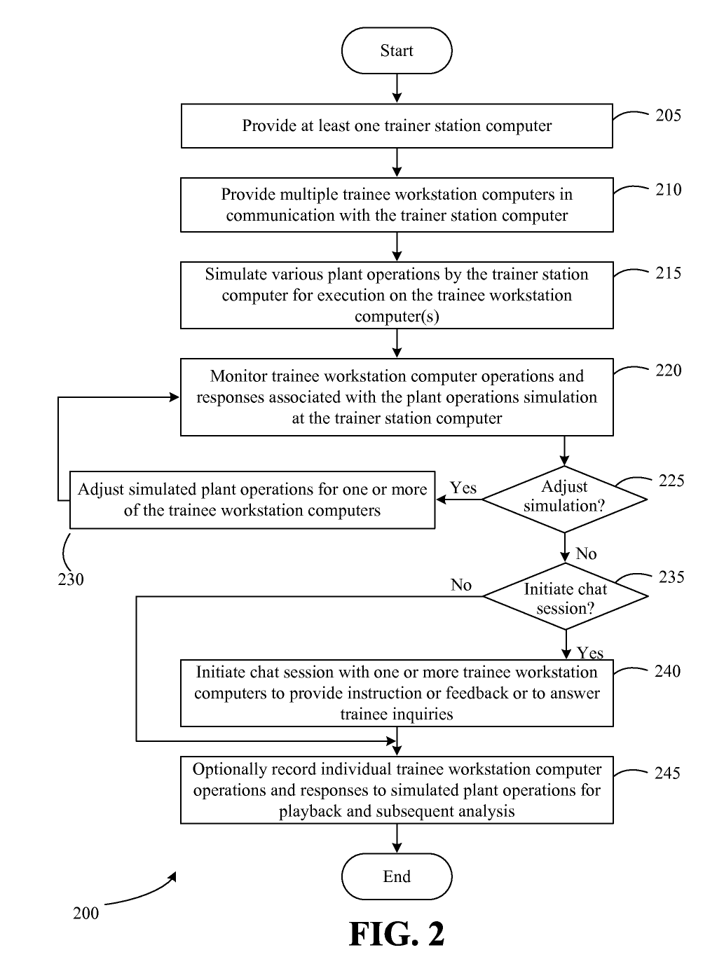

With reference to FIG. 2, a flowchart representing a method 200 illustrating example operations for distributed simulation training is provided, according to one embodiment. The method 200 may be performed by a distributed training simulation system, such as the distributed training simulation system 100 illustrated in and described with reference to FIG. 1. Accordingly, at least a portion of the method 200 may be performed by a trainer station computer 105, which may include a simulation training module 150, a review and analysis module 155, and/or a communications module 160, and at least a portion performed by one or more trainee workstation computers 120a-120n.

The method 200 may begin at block 205, in which at least one trainer station computer is provided. In some embodiments, more than one trainer station computers may be provided, such as if multiple computers are utilized to provide training simulations and/or interface with the trainee workstation computers, or if multiple trainers participate in the distributed simulation training. Similarly, following block 205 is block 210, in which multiple trainee workstation computers are provided in communication with the trainer station computer, such as over a network, for example the network 115 described with reference to FIG. 1. As stated herein, according to some embodiments, one or more of the trainee workstation station computers may be located remotely from the trainer station computer.

Following block 210 is block 215, in which plant operations (or other system) are simulated utilizing one or more simulation programs. In one embodiment, the trainer station computer is operable to generate the training simulations, which are transmitted to or otherwise accessed by the trainee station computers. However, in other embodiments, the trainer station computer may facilitate simulation of plant operations by accessing one or more other processor-based systems operable for simulating plant operations. It is appreciated that, the one or more other processor-based systems may be, but is not limited to, a model-based control system adapted for interfacing with live operating plant systems and equipment, which allow providing realistic modeling of plant operations based on actual plant operations. However, in other embodiments, the trainer station computer or any other processor-based system may instead provide a software-based simulation of the plant operations that does not interface, communicate with, or otherwise depend upon live plant operations.

In one embodiment, at block 215, the trainee station computer or other processor-based system may generate and provide plant simulations by simulating plant operation operating at a first operating state under a first set of conditions. This first operating state and first set of operating conditions may be the same for each of the trainee workstation computers, or a different operating state and/or set of conditions can be provided to one or more of the trainee workstation computers (e.g., such as if one or more trainees have different levels of experience or are being trained for different reasons, etc.). Example operating states may include, but are not limited to, system start up, system shut down, component synchronization (e.g., generator synchronization, etc.), component loading (e.g., generator or turbine loading, etc.), steady state operations, system or component ramp up, system or component ramp down, or any other operating state as desired depending upon implementation. Example operating conditions may include, but are not limited to, ambient conditions, operating temperatures, exhaust temperatures, exhaust levels, humidity, pressure levels, flow rates, power rating, any of which may be at satisfactory levels or degraded levels.

Thus, based on the training simulation data generated by the trainer station computer, one or more of the trainee workstation computers may be operable to display via a simulated control system interface (e.g., a HMI, etc.) the simulated operating state and operating conditions of the plant. In response, the trainees can enter commands to the trainee workstation computers responding to the simulated operating state and operating conditions (e.g., via an HMI, etc.) in an effort to control the simulated plant operations as part of the training.

It is appreciated that, in one embodiment, the trainer station computer communicates simulation data directly to each of the trainee workstation computers over the network, such as when the trainer station computer is configured as a server in a client-server based architecture. However, in other embodiments, the trainer station computer may cause the simulation of plant operations to be generated on another computer, such as a web server or other network server, which is accessed by the trainee workstation computers over a network. Thus, aspects of the trainer station computer, such as the simulation training module 150 described with reference to FIG. 1, can be operable to generate and/or otherwise cause plant simulation operations locally and/or remotely, which may be accessed by or otherwise provided on the trainee workstation computers.

Following block 215 is block 220, in which trainee operations and responses are transmitted from the trainee workstation computers over the network to the trainer station computer for monitoring as part of the training by the trainer. The trainer station computer may include programming instructions operable to display, record, store, replay, and analyze trainee operations and responses to training simulations. Numerous user interfaces may be provided by the trainer station computers, which, according to various embodiments, may be operable to: selectively display all response data from all trainee workstation computers; selectively display all response data from a subset (one or more); selectively display a portion of the response data from one or more of the trainee workstation computers; display response data occurring over selected time periods; display response data associated with selected operations; analyze and display performance data associated with one or more of the trainee workstation computers; analyze and display performance data associated with one or more of the training simulations; allow review of at least a portion of the response data collected from one or more of the trainee workstation computers; allow storage of at least a portion of the response data collected from one or more of the trainee workstation computers; and the like.

Following block 220 is decision block 225, in which it is determined whether the training simulation is to be adjusted by the trainer. For example, as part of the training program, the trainer may adjust an operating state and/or one or more operating conditions, such as by adjusting operating values, etc., for one or more of the trainees. Adjustment allows providing different training scenarios and plant operations to different trainees at different times during the training session. If adjustments are to be made, then operations continue to block 230.

At block 230, adjustments can be made to the training simulation presented to one or more of the trainee workstation computers, including, but not limited to: changing operating states (e.g., start up, shut down, component synchronization, component loading, steady state, ramp up, ramp down, etc.); changing one or more machine conditions (e.g., ambient conditions, operating temperatures, exhaust temperatures, exhaust levels, humidity, pressure levels, flow rates, power rating, etc.); simulating a malfunction scenario; changing one or more signal values or other measured value representations; simulating an alarm condition; and the like. The trainer station computer may include programming instructions operable to present one or more user interfaces to allow input and/or selection by a trainer to adjust the training simulation.

In one example, the trainer station computer may include programming instructions operable to permit the trainer to select from memory one or more previously run conditions, operating states, malfunction scenarios, or other simulated plant statuses, which may have been simulated during a current training session or a previous training session. Thus, a trainer may “restore” the simulation to a previous state, which may be helpful to easily revert back to a previously simulated state, such as if to allow a trainee to attempt the simulated scenario again or to restore the simulation back to a steady state with which the trainees and/or the trainers are familiar.

After block 230, operations repeat back to block 220 in which the trainee operations and responses to the adjusted simulations are again transmitted from the trainee workstation computers over the network to the trainer station computer for monitoring by the trainer. It is appreciated that during a single training session, the method 200 may repeat the operations of blocks 220-230 any number of times, allowing numerous training scenarios and operations to be simulated.

Following block 225, is decision block 235, in which it is determined whether a chat session is to be initiated between the trainer station computer and one or more of the trainee workstation computers. If chat sessions are to be initiated, then block 240 follows. Otherwise, operations continue to block 245.

At block 240, a communications module of the trainer station computer can be operable to initiate a chat session with one or more computers, which may be a text-based chat session, a voice-based chat session, facetime or real-time video interaction, or which may otherwise include email correspondence, private message communications, and the like, and which may be communicated over the network. The chat sessions may be utilized to provide personal messages to specific trainee workstation computers, such as for providing training tips or guidance during a training session or providing personalized instruction. Chat sessions may also be utilized to broadcast messages to all of the trainee workstation computers. In addition, in some embodiments, trainee workstation computers may be operable to initiate a chat session with the trainer station computer, such as for asking questions, providing responses to training inquiries, providing status updates, and the like. It is further appreciated that chat sessions may be initiated and communicated over the network between different trainee workstation computers, such as for allowing collaboration between trainees.

Following block 240 is block 245, in which response data provided at the trainee workstation computers is captured and stored in memory, allowing for subsequent playback and response. According to one embodiment, a review and analysis module of the trainer station computer may receive response data from one or more of the trainee workstation computers, such as the data received and monitored at block 220. Upon receipt, some or all of the response data may be stored in memory for subsequent retrieval and analysis. In one embodiment, all of the trainee's responses and control commands to the training simulation conditions are stored in memory, allowing subsequent retrieval and analysis of all or a portion thereof. In other embodiments, however, the trainer station computer may include programming instructions operable to permit selective capture of a trainee's responses and control commands.

The stored response data thus allows subsequent retrieval and analysis of the response data at the trainee station computer. In one embodiment, retrieval and replay may include step-by-step playback (e.g., video screen capture and playback) representing the trainee's responses and reactions to the training simulation. In another embodiment, retrieval may include a text and/or graphics based report providing one or more of: the trainee's responses; the simulation conditions; the resulting plant performance; trainer notes; trainee notes; and the like.

The method may end after block 245, having providing a distributed simulation training system and providing training simulation amongst multiple different trainee workstation computers, while also monitoring, capturing, and optionally replaying trainee response data. It is appreciated that the operations of the method 200 are described for illustrative purposes, but that in some implementations, the operations of one or more of the blocks may be repeated multiple times and/or may occur out of order. For example, a trainer station computer may initiate a chat session and subsequently adjust the training simulations for additional cycles of training scenarios.

FIG. 3 illustrates by way of a block diagram an example computer system 300, such as may represent the trainer station computer 105 or the trainee workstation computers 120a-120n, described with reference to FIG. 1, according to an illustrative embodiment. More specifically, the computer system 300 may include a memory 310 that stores programmed logic 320 (e.g., software), which may include the simulation training module 150, the review analysis module 155, and the communications module 160, and may store data 330, such as plant operations simulations and associated scenarios, trainee response data, performance measurements, and the like. The memory 310 also may include an operating system 340. A processor 350 may utilize the operating system 340 to execute the programmed logic 320, and in doing so, also may utilize the data 430. A data bus 360 may provide communication between the memory 310 and the processor 350. Users may interface with the computer system 300 via at least one user interface device 370 such as a keyboard, mouse, control panel, or any other devices capable of communicating data to and from the computer system 300. The computer system 300 may be in communication with one or more other computer systems, via an I/O Interface 380, such as via the network 115. More specifically, one or more of the computer systems 300 may carry out the methods described with reference to FIG. 2, including facilitating plant operation simulations, communicating between trainer and trainee computers, display simulations at trainee computers, receive trainee responses and control instruction input, monitor trainee response data, facilitate chat sessions and other communications between trainer and trainee computers. Additionally, it should be appreciated that other external devices, such as components of a live plant or other components of a training system, may be in communication with the computer system 300 via the I/O Interface 380. The computer system 300 and the programmed logic 320 implemented thereby may include software, hardware, firmware, or any combination thereof. It should also be appreciated that multiple computers 300 may be used together, whereby different features described herein may be executed on one or more different computers 300.

Accordingly, embodiments of the systems and method described herein provide distributed training simulation platform operable to allow at least one trainer to control more than one different training simulation at different trainee workstation computers, while also interacting with each of the trainees. Thus, at least a single trainer can train all trainees at a time, while still providing personalized training and unique training simulations to each trainee if desired. At any point, at least one trainer may control trainee simulations to allow adjusting the simulation condition, such as to alter the training scenario provided, save the operations performed by the trainee, or to restart the same or similar scenario. By this distributed training simulation platform, a trainer can view the actions and responses of the trainees, record the actions and responses of the trainees, and interact, such as through text-based or voice-based chat sessions, with each of the trainees.

Therefore, this system provides the technical effect of an efficient and cost-effective training platform that increases training flexibility, while reducing demand on trainers, trainees, and reduces costs. One technical effect achieved includes a system operable to allow a single trainer to interact differently with multiple trainees in parallel. These systems also provide the technical effects of: improving proficiencies of system operators; reducing plant start up times due to more proficient system operators; reducing forced outages by allowing more flexible training scenarios and providing system operator preparedness for unique cases; improving safety of system operations; and improving operator response time and accuracy of responses. Additional technical effects may include: improving the ability to share knowledge by storing training simulation scenarios, specific sessions, and session results; adjusting to and certify system operations and/or operator proficiencies under changing operating and control conditions (e.g., changing regulations and other standards, etc.); and minimizing training time by allowing distanced training over a network by a single trainer while still allowing flexible training simulations for each trainee as desired.

References are made to block diagrams of systems, methods, apparatuses, and computer program products according to example embodiments of the invention. It will be understood that at least some of the blocks of the block diagrams, and combinations of blocks in the block diagrams, respectively, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based, or programmable consumer electronics, mini-computers, mainframe computers, etc.

Application programs that are components of the systems and methods described herein may include routines, programs, components, data structures, etc. that implement certain abstract data types and perform certain tasks or actions. In a distributed computing environment, the application program (in whole or in part) may be located in local memory, or in other storage. In addition, or in the alternative, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated the invention may be embodied in many forms and should not be limited to the example embodiments described above. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A system for simulating plant operations, comprising:
a trainer station computer in operable communication with a plurality of trainee workstation computers;
wherein the trainer station computer is operable to:
facilitate simulation of plant operations on at least one of the plurality of trainee workstation computers; and
monitor operations performed by at least one of the plurality of trainee workstation computers; and
wherein at least one of the plurality of trainee workstation computers is operable to:
display the simulation of plant operations to a user;
receive control instructions input to cause a change in the simulation of plant operations; and
transmit to the trainer station computer information associated with at least one of: (a) the control instructions input; or (b) the change in the simulation of plant operations.

2. The system of claim 1, wherein, when facilitating simulation of plant operations or monitoring operations, the trainer station computer executes instructions to a network-based application accessed by at least one of the plurality of trainee workstation computers.

3. The system of claim 2, wherein the network-based application comprises an Internet-based application.

4. The system of claim 2, wherein the network-based application comprises a private network-based application.

5. The system of claim 1, wherein, when facilitating the simulation of plant operations, the trainer station computer adjusts the simulation of plant operations and monitors operations performed on the at least one of the plurality of trainee workstation computers in response thereto.

6. The system of claim 1, wherein the trainer station computer is operable to initiate a chat session with the at least one of the plurality of trainee station workstation computers.

7. The system of claim 1, wherein the plurality of trainee workstation computers are operable to initiate respective chat sessions with the trainer station computer.

8. The system of claim 1, wherein the trainer station computer is operable to facilitate a first simulation of plant operations on a first training workstation computer and a second simulation of plant operations on a second training workstation computer.

9. The system of claim 8, wherein the first simulation of plant operations simulates different plant operations than the second simulation of plant operations.

10. The system of claim 8, wherein the first simulation of plant operations is associated with a first plant component and the second simulation of plant operations is associated with a second plant component different than the first plant component.

11. The system of claim 1, wherein at least one of the plurality of trainee workstation computers is operable to display simulations of plant operations and to receive the control instructions input via a human machine interface application.

12. The system of claim 1, wherein the trainer station computer is operable to facilitate the storage in memory of data representing at least one of (a) control instructions input at the at least one of the plurality of trainee workstation computers, or (b) the change in the simulation of plant operations resulting from the control instructions, for subsequent retrieval by the trainer station computer.

13. A method for simulating plant operations, comprising:
providing a trainer station computer;
providing a plurality of trainee workstation computers in operable communication with the trainer station computer;
simulating plant operations on at least one of the plurality of trainee workstation computers;
monitoring operations performed by at least one of the plurality of trainee workstation computers; and
transmitting from the at least one of the plurality of trainee workstation computers to the trainer station computer information associated with at least one of: (a) control instructions input at the at least one of the plurality of trainee workstation computers; or (b) a change in the simulation of plant operations resulting from the control instructions.

14. The method of claim 13, further comprising:
adjusting the simulation of plant operations in response input received at the trainer station computer; and
displaying on the trainer station computer operations performed on the at least one of the plurality of workstation computers in response to adjusting the simulation of plant operations.

15. The method of claim 13, further comprising initiating a chat session between at least one of the plurality of trainee station workstation computers by the trainer station computer.

16. The method of claim 13, further comprising initiating a chat session with the trainer station computer by at least one of the plurality of trainee station workstation computers.

17. The method of claim 13, wherein simulating plant operations on at least one of the plurality of trainee workstation computers further comprises:
facilitating a first simulation of plant operations on a first training workstation computer; and
facilitating a second simulation of plant operations on a second training workstation computer.

18. The method of claim 17, wherein the first simulation of plant operations simulates different plant operations than the second simulation of plant operations.

19. The method of claim 17, wherein the first simulation of plant operations is associated with a first plant component and the second simulation of plant operations is associated with a second plant component different than the first plant component.

20. A system for simulating plant operations, comprising:
a trainer station computer in operable communication with a plurality of trainee workstation computers;
wherein the trainer station computer is operable to:
facilitate simulation of plant operations on a plurality of trainee workstation computers representing at least two different simulation conditions or at least two different plant components on at least two different trainee workstation computers; and
monitor operations performed by at least one of the plurality of trainee workstation computers.
